(19) United States
(12) Patent Application Publication
(10) Pub. No.: US 2010/0076586 A1
(43) Pub. Date: Mar. 25, 2010

(54) POSITIONING APPARATUS

(75) Inventors: Georgo Zorz Angelis, Eindhoven (NL); Peter Hoekstra, Eindhoven (NL); George Arie Jan De Fockert, Apeldoorn (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (DE)

(21) Appl. No.: 12/447,274

(22) PCT Filed: Oct. 25, 2007
(86) PCT No.: PCT/IB07/54336

§ 371 Date: Apr. 27, 2009

(30) Foreign Application Priority Data
Oct. 30, 2006 (EP) 06123188.2

(51) Int. Cl. G06F 19/00; B23P 11/02; G05D 3/00

(52) U.S. Cl. 700/117; 29/446; 700/60

(57) ABSTRACT

A positioning device (11) comprises a stationary frame (2), and at least two scales (20, 30) for measuring the location of the platform with respect to the frame, the scales having mutually different pitches (P1; P2), and respective scanners (23, 33) providing respective scanner output signals (SM 1, SM2)—A controller (6) receiving both scanner output signals is capable to uniquely calculate the position (X) of the platform with respect to the frame in a measuring range (MR) that is larger than the largest of said two pitches (P1; P2).

### FIELD OF THE INVENTION

The present invention relates in general to the field of positioning devices and position measuring devices, but the present invention can also be usefully applied in other areas. For sake of explanation, the present invention will be described in the context of a positioning device.

### BACKGROUND OF THE INVENTION

FIG. 1 is a block diagram schematically illustrating some basic components of a positioning device 1, which comprises in general a stationary mounted frame 2, a displaceable platform 3 or the like, that can be displaced with respect to the frame, an actuator 4 for displacing the platform with respect to the frame, a measuring device 5 for measuring the location of the platform with respect to the frame, and a controller 6 for controlling the actuator on the basis of measuring signals received from the measuring device. In FIG. 1, the displacement is illustrated as a linear displacement (translation) in horizontal direction 7; alternatively, a rotational displacement is possible, but this is not illustrated. An example of a positioning device of this type may be a positioning table for positioning a workpiece with respect to a machining tool, or for positioning a printed circuit board with respect to a component placement apparatus.

Accurate position measuring devices for measuring the relative position of two objects that are displaceable with respect to each other are known per se. Generally speaking, a position measuring device comprises two measuring components, the one being fixed with respect to one of said objects, the other being fixed with respect to the other object. One of said measuring components will be indicated as a scale having scale divisions, the other measuring components will be indicated as a scale runner. The runner comprises a scanner for scanning the scale and for outputting a scan signal. On displacement of the two objects, the runner runs along the scale, and the scan signal varies in conformity with the displacement.

By way of example, FIG. 2A illustrates an optical embodiment of a position measuring device, where the scale 20 comprises an alternating pattern of white spots 21 and black spots 22, and where the scanner 23 comprises a light source (not shown) producing a light spot 24 on the pattern of black and white spots. The light is reflected by the pattern and received by a sensor (not shown) of the scanner 23, which generates an output signal S_{M} indicating the amount of light received by the sensor: a high sensor signal H corresponds to the white spots 21 and a low sensor signal L corresponds to the black spots 22, as illustrated in the graph.

By way of further example, FIG. 2B illustrates a magnetic embodiment of a position measuring device, where the scale 26 comprises a series of magnets having their north poles and south poles located in an alternating pattern, and where the scanner 27 comprises a magnetic field sensor such as a Hall sensor, which generates an output signal S_{M} indicating magnitude and direction of the magnetic field sensed by the sensor: a high sensor signal H corresponds to the north poles N and a low sensor signal L corresponds to the south poles Z (or vice versa), as illustrated in the graph.

Alternative embodiments are possible as well. For instance, an embodiment with a capacitive sensor is also possible.

In the following, the extent of the displacement freedom of the platform (i.e. the collection of all possible positions) will be indicated as position range.

In the context of the present invention, it is an advantageous feature of these measuring devices that the detector output signal is an analogue output signal that has a unique relationship with the said relative position between scanner and scale. With the phrase “unique relationship” is meant that for different positions the measuring signals are different, and that each value of the measuring signal occurs only once, so that, if the value of the measuring signal is known, the position can be calculated. Expressed differently: if S_{M}=f(X) is a function that defines the measuring signal S_{M} as a function of the position X on some domain Xd, there exists an inverse function ƒ⁻¹ that, on the domain Xd, uniquely defines the position X=ƒ⁻¹(S_{M}) as a function of the measuring signal. This in contrast to a counter, which provides a digital output signal that is increased (or decreased) by 1 each time the scanner crosses a border between two scale divisions.

Advantageously and consistent with prior art embodiments, function ƒ has a more or less sine-shaped waveform as function of place, but this is not essential.

It is noted that in the above examples, where the function ƒ has a more or less sine-shaped waveform as function of place, each value of the measuring signal occurs twice during in the pitch interval (defined as white 21+black 22; north N+south Z etc.), which seems to be in contradiction to the above-defined requirement of “unique relationship”. However, the scanners are designed to uniquely determine via a second measurement whether they are located at a position where the place-derivative of the measuring signal is positive or negative, so that the scanner is capable to distinguish between the two locations where a certain measuring value occurs. This distinction, in the form of a plus-sign or minus-sign, is also considered part of the entire measuring signal, and this combined signal is unique on the domain Xd, i.e. within a pitch interval. In prior art embodiments the second measurement is often a 90 degree out of “pitch phase” measurement with respect to the first measurement. In that case, for sinusoidal measurements Xmi, the position X can be uniquely determined on the domain Xd, i.e. within a pitch interval, by the function C*a tan 2(Xm1,Xm2), C being a constant. It is noted that the function a tan 2(Y,X) is a function of the two variables Y and X, similar to a tan(Y/X), but acknowledging the sign of the variables to determine the quadrant. Particularly, for a point having coordinates X and Y, the function a tan 2(Y,X) gives the angle between the radius and the x-axis, this angle being between 0 and π if Y is positive and being between 0 and −π if Y is negative.

From the above, it should be clear that, as a function of place, the scanner output signal S_{M} is a periodical signal (a sine-shaped place-dependency is not essential). The signal period reflects a periodicity of the scale, also indicated as pitch: in the above embodiments, the scale periodicity corresponds to the combination of two scale divisions (white 21+black 22; north N+south Z). In the following, a portion of the position range corresponding to one scale period will be indicated as position field.

At first sight, it might seem that scales of the above-mentioned type are only capable of giving very rough position information, with a spatial accuracy corresponding to the size of the divisions. However, the accuracy of scales of the above-mentioned type is actually quite good. When the platform is displaced with respect to the frame, the measuring signal varies according to its characteristic waveform, and the phase of the measuring signal within the scale period corresponds to the spatial displacement in a linear fashion, e.g. function C*a tan 2(Xm1,Xm2) as defined above. In practice, the spatial accuracy can easily be 1000 times (or even more) better than the size of the divisions.

Further, the positioning device may have a positioning range larger than the scale period. When the platform is displaced with respect to the frame, the controller notes the number of signal periods that are passed; or, in an alternative description, the controller may consider the phase of the measuring signal to be higher than 360°. In any case, the controller will be capable of accurately keeping track of the displacement of the platform over the entire displacement range, which means that the controller will be capable of knowing the relative position of the platform over the entire displacement range, assuming of course that the size of the scale is at least equal to the displacement range. However, the actual measuring signal only shows values that correspond to a measuring phase between 0° and 360°, and a problem emerges on start-up, when the controller does not “know” where the platform is located initially. On the basis of the measuring signal alone, the controller only uniquely knows the phase of the position with respect to the scale period, but the controller does not know within which position field. Thus the absolute position is unknown.

To solve this problem and to determine uniquely the position for the entire displacement range (i.e. multiple pitches), prior art positioning devices perform an initialization procedure, wherein the platform is driven to an accurately known start position. This typically involves driving the platform towards a well defined end stop or well defined index sensor. Such initialization procedure involves several disadvantages. First, making the platform bump against a stop is undesirable. Further, it is difficult to select an adequate speed for initializing: the controller does not know where the platform is, i.e. far away from the stop or very close to the stop. To reduce the risk of high-velocity bumps, the displacement speed must be set relatively low, but if the platform is far away from the stop, the initialization procedure requires much time. Further, such initialization is rather difficult in a case where the platform has six degrees of freedom.

### SUMMARY OF THE INVENTION

The present invention aims to overcome or at least reduce the above drawbacks of earlier art.

Specifically, the present invention aims to provide a relatively simple and low-cost position detecting apparatus providing absolute position determination within a large range beyond a pitch, i.e. multiple pitches.

According to an important aspect of the present invention, a position measuring device comprises at least two scales extending along the desired displacement range of the platform, with corresponding scanners, where at least two scales are used that have different scale periods (period 1 and period 2) and are chosen such that the displacement range is equal or smaller than the least common multiple of period1 and period2. In this case the (initial) position can be determined uniquely over the displacement range. The controller receives the measuring signals of both scanners. Although each scanner output signal has a unique value over only a relatively small displacement range (i.e. the position field corresponding to one scale period), the combined signals have a unique combination of values over a relatively large displacement range. Thus, on power-up, without the necessity to perform initialization, the controller can derive the absolute position of the platform from the combined signals.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically illustrating a positioning device;

FIG. 2A schematically illustrates an optical embodiment of a position measuring device;

FIG. 2B schematically illustrates a magnetic embodiment of a position measuring device;

FIG. 3 is a block diagram schematically illustrating a positioning device according to the present invention;

FIG. 4 is a graph showing the relationship between phase of the measuring signal and location.

### DETAILED DESCRIPTION OF THE INVENTION

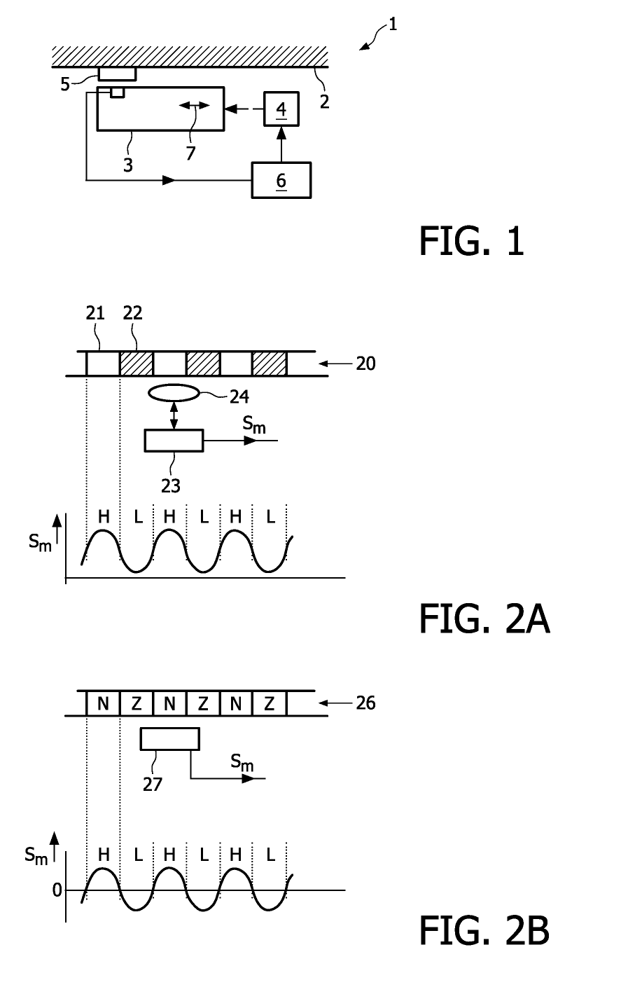

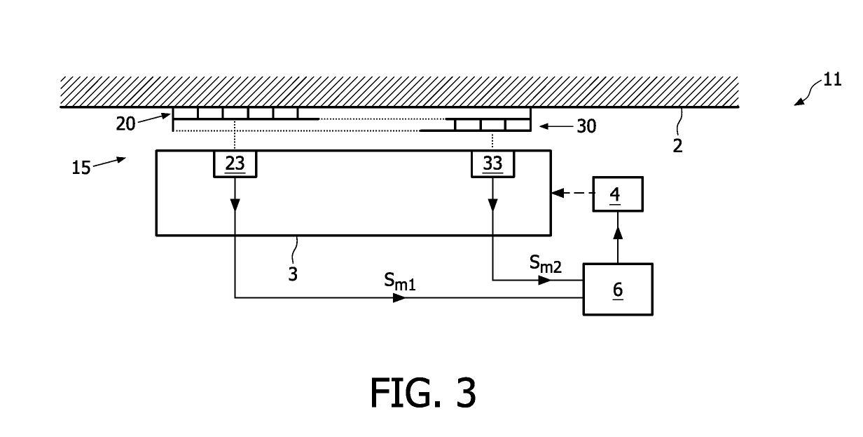

FIG. 3 is a block diagram comparable to FIG. 1, schematically illustrating a positioning device 11, which comprises a measuring device 15 for measuring the location of the platform with respect to the frame. The measuring device 15 comprises a first scale 20 with associated scanner 23 and a second scale 30 associated scanner 33. The measuring signal produced by the first scanner 23 is indicated as S_{M1}, while the measuring signal produced by the second scanner 33 is indicated as S_{M2}. The two scales 20 and 30 have mutually different pitches P1 and P2, respectively; in the example, P2>P1 applies.

When the platform 3 is displaced, the first scanner 23 is displaced along the first scale 20 and the second scanner 33 is displaced along the second scale 30. The first scanner output signal S_{M1} is spatially periodical with a period equal to P1. The second scanner output signal S_{M2} is spatially periodical with a period equal to P2.

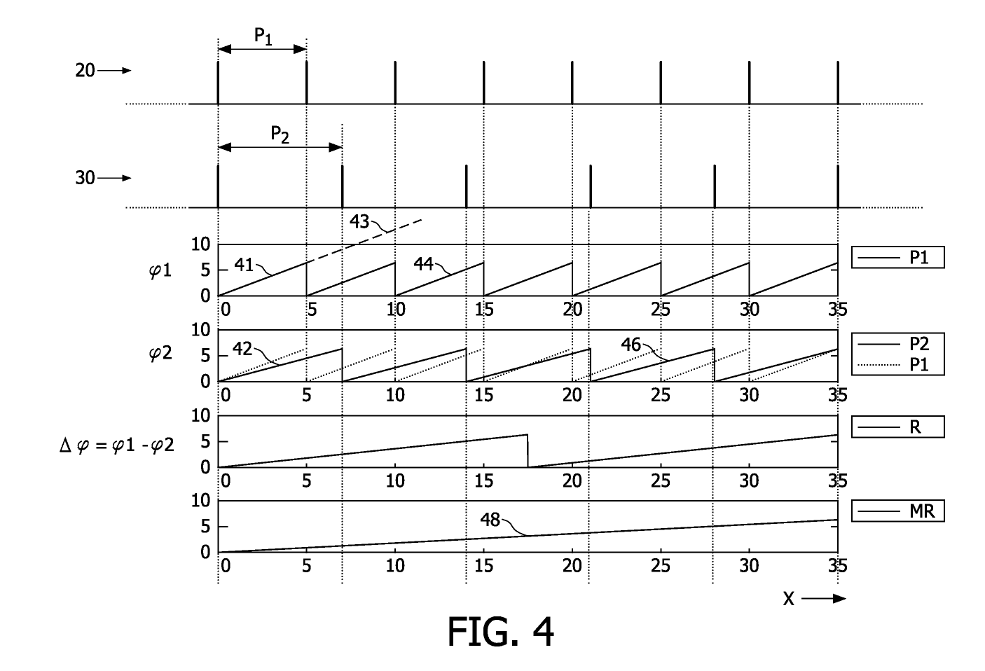

Illustratively, the controller 4 is capable of calculating the phase φ1 and φ2 of the two output signals S_{M1} and S_{M2}, respectively. It is noted that this phase can be calculated as described in section BACKGROUND OF THE INVENTION. FIG. 4 is a graph schematically showing these phases φ1 (line 41) and φ2 (line 42) as function of the location x (horizontal axis) of the platform 3. Starting from a certain position zero, the figure shows that the phase φ1 increases linearly until φ1=2π is reached when the location x reaches P1. Dotted line 43 indicates φ1 as a linear function of the location beyond P1; however, the scanner can not distinguish between the first position field and the next one, and the phase φ1 can only take values between 0 and 2π, so the sawtooth line 44 indicates the actual relationship between phase and position.

Similarly, sawtooth line 46 indicates the actual relationship between second phase φ2 and position.

Illustratively, the controller 4 is also capable of calculating the phase difference Δφ=(φ1−φ2)[mod 2π]. With the notation [mod 2π] is meant that an integer number of factors 2π is added to or subtracted from the outcome of the subtraction φ1−φ2 such that the result has a value between 0 and 2π. FIG. 4 also shows this phase difference Δφ as a function of the position (line 48). It can clearly be seen that this phase difference Δφ also increases linearly with the position x, but at a much slower rate, so that the phase difference Δφ rises from 0 to 2π over a range R that is larger than the first pitch P1 and larger than the second pitch P2. Over this entire range R, there is a one-to-one relationship between phase difference Δφ and position x, so the phase difference Δφ can be used to unambiguously determine the absolute position of the platform over the entire range R.

Actually, the measuring device 15 can be considered as comprising a scale device (combination of scales 20 and 30) with a pitch R, and further comprising a scanning device (combination of scanners 23 and 33) providing an output signal (combination of signals S_{M}1 and S_{M}2) that is spatially periodical with period R. In the following, this range R will be indicated as “combination pitch”.

It can be shown that said combination pitch R can be expressed as follows:

$$R = \frac{{P}_{1} \cdot {P}_{2}}{{P}_{1} - {P}_{2}}$$

so the combination pitch R becomes larger as P1 and P2 are closer together.

The measuring range (MR) i.e. the range for which the absolute position can be uniquely determined, is with this invention extended beyond the combination pitch R for certain combinations of periodic scales (P1,P2) with the present invention. Furthermore, given a desired measuring range MR the pitch combinations that embody the present invention allow the absolute position to be determined uniquely on this range is extended to periodic scales for which it holds that the least common multiple of the periodic scales is equal or greater than MR. A few examples are given below.

### Example 1

Assume a first scale with a pitch P1=6 mm and a second scale with a pitch P2=7 mm. In such case, combination pitch R is equal to 42 mm.

In this example, first pitch P1 fits an integer number of times into combination pitch R, i.e. 7 times. Likewise, second pitch P2 fits an integer number of times into combination pitch R, i.e. 6 times. Consequently, when Δφ=2π at the end of the range R, φ1 and φ2 are also equal to 2π (modulo 2π). However, this is not necessarily always the case.

### Example 2

Assume a first scale with a pitch P1=5 mm and a second scale with a pitch P2=7 mm (see FIG. 4). In such case, combination pitch R is equal to 17.5 mm. However, when Δφ=2π at X=R, φ1 and φ2 are equal to it (modulo 2π). Thus, it is possible for the controller 6 to unambiguously determine a position even beyond said combination pitch R, by considering the value of the phase difference Δφ in combination with the values of first and/or second phases φ1 and φ2. This means that the measuring device 15 has a measuring range MR larger than the combination pitch R; in this example, MR=2R applies.

In the above examples, the pitches are integer numbers. However, this is not essential.

### Example 3

Assume a first scale with a pitch P1=4.99 mm and a second scale with a pitch P2=4.93 mm. In such case, combination pitch R is (approximately) equal to 41 cm.

In this example, when Δφ=2π at X=R, φ1 and φ2 are equal to π/6 (modulo 2π). Thus, the combination of φ1 and Δφ is still unique for X>R, and the measuring range MR in this example is six times as large as the combination pitch R: MR is approximately equal to 246 cm.

The present invention can be embodied while using two (or more) highly accurate scales, of which the respective pitches are accurately arranged on the scales. Such scales would be expensive. The invention surprisingly has found that high accuracy is not required. In fact, it is possible to use two different scales which were manufactured with the intention to be equal but which, due to tolerances, factually have slightly different pitches. The actual pitch difference will be a matter of chance, but, for practicing the present invention the actual value of the pitch difference is not crucial. With reference to the above example 3, it should be clear that it is not very important whether the pitch difference is equal to 0.06 mm or 0.07 mm, so an inaccuracy of 10% or more would be acceptable.

Instead of relying on manufacturing tolerances, it is also possible to provide a pair of scales with deliberate pitch differences. The present invention relates to certain different methods for providing such pair of scales.

In a first method, two substantially equal scales are taken, with mutually substantially equal pitches. The two scales are arranged such that the temperature of one of them is higher than the temperature of the other one. As a result, due to differences in thermal expansion, the pitches will be slightly different.

In a second method, two substantially equal scales are taken, with mutually substantially equal pitches. The two scales are arranged in a tilted position. For instance, one of the scales is mounted parallel to the displacement direction of the platform, the other one is mounted at an angle α, so that the effective pitch is decreased by multiplying the scale pitch with a factor cos(α).

In a third method, which has aspects in common with the first method, two substantially equal scales are manufactured, with mutually substantially equal pitches. However, during the manufacturing process, when the scale divisions are applied, the temperature of the first scale is maintained at a higher level than the temperature of the second scale. After manufacturing, when the two scales have cooled down to room temperature, the first scale has shrunken more than the second one (thermal shrinkage) so its pitch will be slightly less than the pitch of the second scale. In use, it would be advantageous to thermally couple the two scales well together, to assure that they are used at the same temperature. This third method has the advantage that the eventual user does not have to perform specific measures when mounting the two scales.

In all of the above methods, the eventual user must calibrate the arrangement to determine the factual pitches and pitch differences.

Summarizing, the present invention provides a positioning device 11 comprising a stationary frame 2 and at least two scales 20, 30 for measuring the location of the platform with respect to the frame, the scales having mutually different pitches P1; P2, and respective scanners 23, 33 providing respective scanner output signals S_{M1}, S_{M2}. A controller 6 receiving both scanner output signals is capable to uniquely calculate the position X of the platform with respect to the frame in a position measuring range MR that is larger than the largest of said two pitches P1; P2. With respect to prior art embodiments, it also extends the possible choices for the pitches Pi for achieving a predefined desired unique measuring range.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, it is not essential that the measuring signals are continuous or analogue signals; rather, it is possible that the measuring signals are discrete signals having different pitches. For instance, assume a first measuring device that gives integer measuring values from 1 to 10 in a pitch of 8 μm, each measuring value being associated with an interval of 0.8 μm, while a second measuring device gives integer measuring values from 1 to 10 in a pitch of 11 μm, each measuring value being associated with an interval of 1.1 μm. The two measuring signals form a combination that is unique over a distance of 88 μm, after which the combinations repeat themselves. It is noted that an embodiment of this type would be adequate to roughly determine the approximate position of the platform on start-up, in a positioning device having a positioning range of 88 μm or less. Other numerical examples can easily be conceived by a person skilled in the art on the basis of the above information.

In the above, it has been demonstrated that it is possible to have a large measuring range with two measuring scales with mutually different pitches, and the phase difference Δφ has been used to illustrate this large measuring range. However, in practice it is not necessary to calculate a phase difference; it is possible to establish the relationship between position x and measuring phase φ1 and φ2, and based upon that relationship, it is possible to define the inverse relationship, i.e. to define position x as a function of the two parameters φ1 and φ2, for instance in the form of a lookup table.

Further, it is possible to use a third measuring scale with a third pitch P3 differing from the first two pitches P1 and P2, in order to further extend the measuring range.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Positioning device (11), comprising:
a stationary frame (2);
a displaceable platform (3), arranged for displacement with respect to the frame in at least one displacement direction (x);
an actuator (4) for displacing the platform with respect to the frame;
a controller (6) for controlling the actuator;
a position measuring device (15) for measuring the location of the platform with respect to the frame, the position measuring device (15) comprising:
a first scale (20) having first scale divisions with a first pitch (P1) fixed to one of the platform and the frame, and a first scanner (23) fixed to the other of the platform and the frame, the first scanner adapted for scanning the first scale and for providing a first scanner output signal (S_{M1}) which depends on the relative position of the first scanner with respect to the first scale, is periodical with a period equal to the first pitch, and within one first pitch distance has a unique relationship with the said relative position;
a second scale (30) having second scale divisions with a second pitch (P2) fixed to one of the platform and the frame, and a second scanner (33) fixed to the other of the platform and the frame, the second scanner adapted for scanning the second scale and for providing a second scanner output signal (S_{M2}) which depends on the relative position of the second scanner with respect to the second scale, is periodical with a period equal to the second pitch, and within one second pitch distance has a unique relationship with the said relative position;
wherein the second pitch differs from the first pitch;
wherein the controller is coupled to receive the first scanner output signal from the first scanner and to receive the second scanner output signal from the second scanner;
and wherein the controller is designed, on the basis of the received two scanner output signals, to uniquely calculate the position (X) of the platform with respect to the frame in a measuring range (MR) that is larger than the largest of said two pitches (P1; P2).

2. Positioning device according to claim 1, wherein said measuring range (MR) fulfils the relationship
$$M R \geq \frac{{P}_{1} \cdot {P}_{2}}{{P}_{1} - {P}_{2}} .$$

3. Positioning device according to claim 2, wherein said measuring range is the least common multiple of P1 and P2.

4. Positioning device according to claim 1, wherein said two scales (20, 30) are mutually identical, wherein the pitch difference is due to manufacturing tolerances.

5. Positioning device according to claim 1, wherein said two scales (20, 30) are mutually identical, with substantially equal pitch, and wherein said two scales (20, 30) are arranged at mutually different operating temperatures.

6. Positioning device according to claim 1, wherein said two scales (20, 30) are mutually identical, with substantially equal pitch, and wherein said two scales (20, 30) are arranged at an angle with respect to each other.

7. Positioning device according to claim 6, wherein one of the scales is mounted parallel to the displacement direction (X) of the platform, and wherein the other scale is mounted at an angle (α) with respect to the displacement direction (X) of the platform.

8. A method for manufacturing a measuring device comprising two scales, the method comprising the steps of:
manufacturing a first scale with a first pitch at a first manufacturing temperature;
manufacturing a second scale with a second pitch at a second manufacturing temperature, wherein the second pitch is substantially equal to the first pitch and wherein the second manufacturing temperature differs from the first manufacturing temperature;
allowing the two scales to arrive at approximately the same temperature;
firmly attaching the two scales together whilst they have the same temperature, assuring a good thermal contact between said two scales.

9. Measuring device (15) comprising two scales (20, 30) attached together with a good thermal contact between said two scales, manufactured by the method of claim 8.

10. The positioning device according to claim 1, wherein said two scales are attached together whilst they have approximately the same temperature.

11. Position measuring device (15) for measuring the location of two objects (2, 3) with respect to each other, the position measuring device (15) comprising:
a first scale (20) having first scale divisions with a first pitch (P1) for attachment to one of said objects, and a first scanner (23) for attachment to the other of said objects, the first scanner adapted for scanning the first scale and for providing a first scanner output signal (S_{M1}) which depends on the relative position of the first scanner with respect to the first scale, is periodical with a period equal to the first pitch, and within one first pitch distance has a unique relationship with the said relative position;
a second scale (30) having second scale divisions with a second pitch (P2) for attachment to one of said objects, and a second scanner (33) for attachment to the other of said objects, the second scanner adapted for scanning the second scale and for providing a second scanner output signal (S_{M2}) which depends on the relative position of the second scanner with respect to the second scale, is periodical with a period equal to the second pitch, and within one second pitch distance has a unique relationship with the said relative position;
wherein the second pitch differs from the first pitch;
the position measuring device (15) further comprising a controller (6) coupled to receive the first scanner output signal from the first scanner and to receive the second scanner output signal from the second scanner, the controller being designed, on the basis of the received two scanner output signals, to uniquely calculate the position (X) of the two objects with respect to each other in a measuring range (MR) that is larger than the largest of said two pitches (P1; P2).
